(19) United States
(12) Patent Application Publication
(10) Pub. No.: US 2020/0406837 A1
(43) Pub. Date: Dec. 31, 2020

(54) THIN THERMALLY STRENGTHENED GLASS COVER PANEL FOR VEHICLE FRAME ASSEMBLY AND RELATED METHOD

(71) Applicant: CORNING INCORPORATED, CORNING, NY (US)

(72) Inventors: Jeffrey Michael Amsden, Hammondsport, NY (US); Thomas Michael Cleary, Elmira, NY (US); Kurt Edward Gerber, Dansville, NY (US)

(21) Appl. No.: 16/979,220

(22) PCT Filed: Mar. 14, 2019
(86) PCT No.: PCT/US2019/022236

§ 371 Date: Sep. 9, 2020

Related U.S. Application Data
(60) Provisional application No. 62/643,857, filed on Mar. 16, 2018.

(51) Int. Cl. B60R 13/04; B62D 65/16; C03C 17/04; C03C 27/10

(52) U.S. Cl. CPC B60R 13/04; B62D 65/16; C03C 17/04; C03C 2217/72; C03C 2203/52; C03C 2204/04; C03C 27/10

(57) ABSTRACT

A vehicle frame assembly is provided. The vehicle frame assembly includes an outer cover panel formed from a thin, thermally strengthened glass material. The thermally strengthened glass material has high levels of surface compressive stress providing sufficient strength and durability for a vehicle frame cover application. The thermally strengthened glass is also thin (e.g., less than 2 mm) providing a lightweight frame material that is suitable for cold-bending to a curvature needed for the vehicle body shape and/or to match the curvature of the vehicle frame.

### CROSS-REFERENCE TO RELATED APPLICATIONS

This application claims the benefit of priority under 35 U.S.C. § 119 of U.S. Provisional Application Ser. No. 62/643,857 filed on Mar. 16, 2018, the content of which is relied upon and incorporated herein by reference in its entirety.

### BACKGROUND

The disclosure relates generally to a vehicle frame assembly using a strengthened glass cover layer, and specifically to a vehicle frame cover utilizing a thin, thermally strengthened, glass cover panel. Vehicle frames typically include a variety of rigid (typically metal) support pillars, beams, etc. A body panel is typically attached to the frame to provide a shape, color, appearance, etc. as desired to the vehicle body.

### SUMMARY

One embodiment of the disclosure relates to a vehicle frame assembly. The vehicle frame assembly includes a vehicle frame support structure having an interior surface and an exterior surface. The vehicle frame assembly includes a cover panel coupled to the vehicle frame support structure and covering the exterior surface of the vehicle frame support structure. The cover panel includes a glass article. The glass article includes a first major surface, a second major surface opposite the first major surface and separated from the first major surface by a thickness and an interior region located between the first and second major surfaces. The thickness is less than or equal to 2 mm. The glass article is thermally strengthened such that at least one of the first major surface and the second major surface is under compressive stress greater than 60 MPa. The first major surface faces the exterior surface of the vehicle frame support structure.

An additional embodiment of the disclosure relates to a method of forming a vehicle frame assembly. The method includes bending a glass article to a curved shape while a temperature of the glass article is less than a glass transition temperature of the glass article. The glass article includes a first major surface, a second major surface opposite the first major surface and separated from the first major surface by a thickness and an interior region located between the first and second major surfaces. The thickness is less than or equal to 2 mm. The glass article is thermally strengthened such that at least one of the first major surface and the second major surface is under compressive stress greater than 60 MPa. The method includes coupling the glass article to a vehicle frame such that the glass article is held in place relative to the vehicle frame covering a portion of the vehicle frame.

An additional embodiment of the disclosure relates to a glass cover panel for covering a portion of a vehicle frame that includes a thermally strengthened glass article. The thermally strengthened glass article includes a first major surface, a second major surface opposite the first major surface and separated from the first major surface by a thickness that is less than or equal to 2 mm, and an interior region located between the first and second major surfaces. The glass article is thermally strengthened such that at least one of the first major surface and the second major surface is under compressive stress greater than 60 MPa. The glass article is not chemically strengthened such that an ion content and chemical constituency of at least a portion of both the first major surface and the second major surface is the same as an ion content and chemical constituency of at least a portion of the interior region. At least a portion of the first major surface is a curved surface comprising a first radius of curvature, wherein the first radius of curvature is between 500 mm and 3000 mm. The cover panel includes a non-transparent colored layer located on the first major surface of the thermally strengthened glass article.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and the operation of the various embodiments.

### BRIEF DESCRIPTION OF THE DRAWINGS

FIG. 1 is a side view of a vehicle including one or more vehicle frame cover panels, according to an exemplary embodiment.

FIG. 2A is an exploded, cross-sectional view of a vehicle frame assembly including a glass cover panel, according to an exemplary embodiment.

FIG. 2B is a cross-sectional view of a vehicle frame assembly of FIG. 2A following assembly, according to an exemplary embodiment.

FIG. 3A is an exploded, cross-sectional view of a vehicle frame assembly including a glass cover panel, according to another exemplary embodiment.

FIG. 3B is a cross-sectional view of a vehicle frame assembly of FIG. 3A following assembly, according to another exemplary embodiment

FIG. 4 is a front view of a thermally strengthened glass article or sheet for use as a vehicle frame cover panel according to an exemplary embodiment.

FIG. 5 is a diagrammatic partial cross-section of a thermally strengthened glass article of FIG. 4 according an exemplary embodiment.

FIG. 6 is a graphical representation of estimated tensile stress versus thickness for a glass or glass-ceramic article according to an exemplary embodiment.

### DETAILED DESCRIPTION

Referring generally to the figures, various embodiments of a vehicle frame cover panel formed from a thin, thermally strengthened glass article are shown and described. In general, the vehicle frame cover panel discussed herein is formed from a thermally strengthened glass article having a high level of strengthening to provide for high levels of strength, durability, scratch resistance, dicing performance, etc. as needed for a vehicle body or frame cover application. While providing sufficiently high levels of strengthening, the glass article also is very thin (e.g., less than 2 mm) which provides both a low weight frame cover material and a glass material that can be shaped as desired using cold bending processes.

It is Applicant's understanding that prior attempts to utilize thermally strengthened glass in vehicle frame cover applications has focused on thick glass (e.g., typically thicker than 2.8 mm) to provide sufficient levels of strengthening. However Applicant has found that the thick, thermally strengthened glass for frame cover applications adds additional weight to the vehicle. Further, due to the high level of thickness, such prior glass frame cover panels typically required hot bending equipment and processes to form the curved shapes typically desired in vehicle frame cover applications. As such, Applicant believes that the vehicle frame cover panel discussed herein provides a unique combination of low weight, high strength and/or cold-bending that was not achievable with prior thick glass cover panel designs.

In addition, prior vehicle frame cover panels have been formed from plastic materials and from painted metal materials. Applicant believes that the glass frame cover panels discussed herein provide for a variety of improved performance characteristics relative to these alternative cover panel designs. As one example, by utilizing a glass material for the frame cover panel, a consistent body appearance is provided by the frame cover panels located adjacent to the glass vehicle glazing (e.g., vehicle windows, windshield, sunroof, etc.). As compared to plastic frame cover materials, the glass frame cover panels discussed herein provide for a more durable and scratch resistant vehicle body material. As compared to metal cover materials, the glass frame cover panels discussed herein are believed to provide for improved color and appearance matching, glossy appearance and/or scratch resistance. As compared to thicker glass materials, the glass frame cover panels are thin and light while maintaining a high level of strength. Weight reduction in vehicle frame materials has become an increasingly more important design objective to achieve high levels of fuel efficiency and may become even more important in helping to enable practical, low weight, long range electric vehicles.

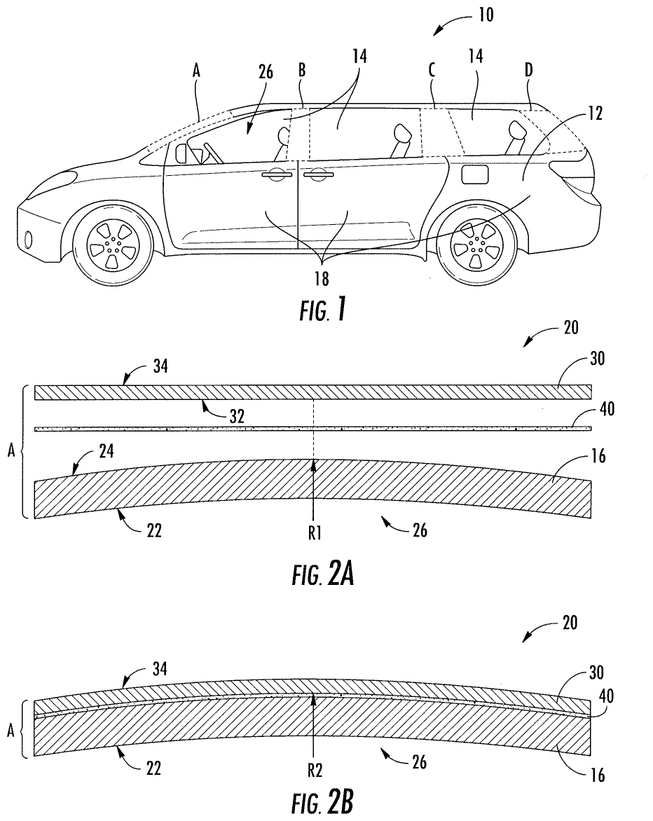

Referring to FIG. 1, a vehicle, such as car 10, is shown according to an exemplary embodiment. Car 10 includes a body 12 and vehicle glazing, shown as one or more vehicle windows 14. As will generally be understood, body 12 includes a frame including a plurality of support structures (see frame pillar 16 in FIGS. 2A and 2B) and a plurality of cover panels, shown as body panels 18 that define at least a portion of the exterior of the vehicle. Some cover panels are pillar cover panels that cover the frame pillars that run along the windows and windshield and that support the roof of the vehicle, and these pillars are typically designated as the A, B, C and D pillars as labeled in FIG. 1.

Referring to FIGS. 2A and 2B, the A pillar vehicle frame assembly, shown as frame assembly 20, is shown according to an exemplary embodiment. It should be understood that while FIGS. 2A and 2B are described in terms of the A pillar frame assembly, the assembly of FIGS. 2A and 2B may be utilized for any frame assembly of car 10 including pillars B, C and D.

As noted above, frame assembly 20 includes a frame support structure, shown as the A pillar 16. Pillar 16 includes an interior surface 22 and an exterior surface 24. Interior surface 22 faces toward the vehicle interior and/or vehicle passenger compartment 26, and exterior surface 24 faces outward toward the exterior of the vehicle.

Frame assembly 20 includes a cover panel 30. In general, cover panel 30 is coupled to pillar 16 such that its exterior surface 24 is covered by cover panel 30. In the embodiments discussed herein, cover panel 30 is formed from a thin thermally strengthened sheet or article of glass material (as will be discussed in more detail below regarding FIGS. 4-6). Cover panel 30 includes a first major surface, shown as interior surface 32, that faces exterior surface 24 of pillar 16 and a second major surface, shown as exterior surface 34.

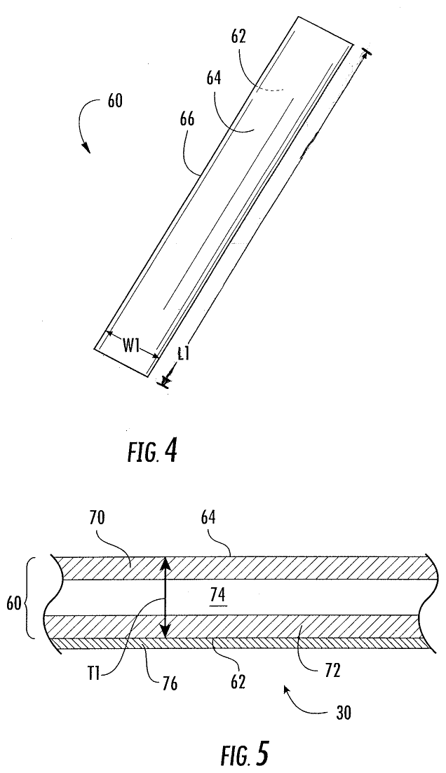

In general and as shown in FIGS. 4 and 5, cover panel 30 includes a thin, thermally strengthened glass sheet or article (e.g., a soda-lime glass article) that has a thickness (e.g., an average thickness or a maximum thickness) measured between its opposing major surfaces of less than 2 mm, and the glass article of cover panel 30 is thermally strengthened such that at least one of its major surfaces have a surface compressive stress greater than 60 MPa and more specifically greater than 68 MPa. In a specific embodiment, the glass article of cover panel 30 has a thickness of 0.5 mm to 2 mm, and at least one of its major surfaces have a surface compressive stress greater than 100 MPa. Additional details of the glass article that forms cover panel 30 are described below regarding FIGS. 4-6.

In various embodiments, interior surface 32 and/or exterior surface 34 of cover panel 30 are defined by the glass material of the glass article of cover panel 30 (see FIG. 5). As will be discussed in more detail below regarding FIG. 5, the glass article of cover panel 30 may include one or more coating layers applied to the glass material, such that interior surface 32 and/or exterior surface 34 of cover panel 30 are defined by a coating material applied to the glass article.

As shown in FIG. 2B, cover panel 30 is coupled to pillar 16 such that cover panel 30 is held in place relative to pillar 16 and such that cover panel 30 covers pillar 16. In specific embodiments in which cover panel 30 is used for pillars A, B, C, D, etc., exterior surface 34 of cover panel 30 defines the outermost surface of the frame assembly 20 and the vehicle body at that location and the peripheral edge of cover panel 30 (shown as broken lines in FIG. 1) are located adjacent to the vehicle glazing. In specific embodiments, as shown in FIG. 1, pillar 16 extends along a vertically extending edge of a vehicle window 14, and cover panel 30 includes a peripheral edge that extends along (e.g., parallel to) the vertical edge of the vehicle window 14. In such embodiments, the glass material of cover panel 30 provides for a consistent glass appearance between the vehicle glazing and the adjacent cover panel.

In the specific embodiment shown in FIGS. 2A and 2B, cover panel 30 is coupled to pillar 16 via an adhesive material, shown as adhesive layer 40. Adhesive layer 40 is located between exterior surface 24 of pillar 16 and interior surface 32 of cover panel 30. As shown in FIG. 2B adhesive layer 40 bonds cover panel 30 to pillar 16. Adhesive layer 40 may be a wide variety of suitable materials including glues, hot-melt adhesives, curable adhesives, etc. that are applied or positioned as shown in FIGS. 2A and 2B to hold cover panel 30 in position relative to pillar 16. In various embodiments, adhesive layer 40 is at least one of an epoxy, urethane, or structural bonding tape.

In specific embodiments, outer surface 24 of pillar 16 is a curved surface defined by one or more radius of curvature, shown as radius of curvature R1. It should be understood that while the cross-sectional view of FIGS. 2A and 2B show curvature in a single direction, in some embodiments, outer surface 24 of pillar 16 may be a complexly curved surface defined by more than one radius of curvature. In a specific embodiment, outer surface 24 is curved both in the length direction and in the height direction (in the orientation of FIG. 1). As shown in FIG. 2B, interior surface 32 of cover panel 30 is curved, having a second radius of curvature, R2, to substantially match (e.g., within plus or minus 10%) the curvature of outer surface 24 of pillar 16. Thus, in such embodiments, R2 is equal to R1 plus or minus 10%. This shape matching provides a tight fit between cover panel 30 and pillar 16. In specific embodiments, R2 is between 500 mm and 3000 mm. In various embodiments, R2 is greater than 1500 mm, and more specifically is between 1500 mm and 3000 mm.

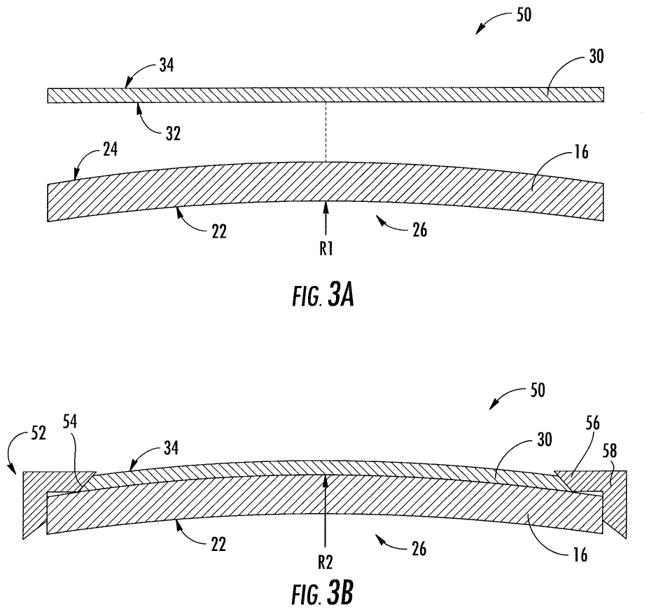

Referring to FIGS. 3A and 3B, the A pillar vehicle frame assembly, shown as assembly 50, is shown according to another exemplary embodiment. Assembly 50 is substantially the same as frame assembly 20, shown in FIGS. 2A and 2B, except for the differences discussed herein. In the embodiment of FIGS. 3A and 3B, assembly 50 is held together by frictional engagement created by panel frame 52.

As shown, cover panel 30 includes a peripheral edge 54 that extends between and surrounds upper and lower surfaces 32 and 34 of cover panel. Panel frame 52 includes a first end, shown as flange 56, which overlaps and engages a portion of outer surface 34 of cover panel 30 adjacent to peripheral edge 54. Panel frame 52 includes a second end, shown as collar 58, which engages a portion of pillar 16. In this manner, the frictional engagement provided by panel frame 52 couples cover panel 30 to pillar 16. In various embodiments, a wide variety of frictional engagement structures, such as snap fit arrangements, press fit arrangements, taper fit arrangements, etc., may be used to provide the frictional coupling between panel frame 52, cover panel 30 and pillar 16. In some embodiments, the frictional coupling of panel frame 52 may be combined with various adhesive materials such as adhesive layer 40 discussed above.

Referring to FIGS. 2A and 2B and to FIGS. 3A and 3B, methods of forming a vehicle frame assembly are shown. To assemble a vehicle frame assembly, such as frame assembly 20 or 50, a cover panel including a thin, thermally strengthened glass article, such as cover panel 30, is bent to a curved shape. In such embodiments, cover panel 30 is bent to a curved shape to match the curvature of pillar 16 as discussed above.

In specific embodiments, cover panel 30 is cold-bent or cold-formed to the curved shape shown in FIGS. 2B and 3B. In such embodiments, cover panel 30 is formed to the curved shape while the temperature of cover panel 30 is less than the glass transition temperature of the glass material of the glass article. In such embodiments, a force is applied (e.g., via a press, a vacuum chuck, etc.) to deform cover panel 30 to the desired curved shape while the cover panel is at a low temperature. Applicant has found that cold-bending allows for efficient and cost effective formation of a cover panel, such as cover panel 30, from a glass material. In particular, in such processes because cover panel 30 is shaped directly onto the pillar 16, the shape match to pillar 16 is very high and reliable (e.g., in contrast to processes that pre-shapes a cover panel based on the specification shape of pillar 16). In particular, Applicant believes that the thin, yet strong thermally strengthened glass material used for cover panel 30 enables the ability to utilize cold bending to form a cover panel while also providing for the level of glass strength needed for a vehicle body or cover application.

In addition, following or contemporaneous with bending, the method of assembling a vehicle frame assembly includes coupling the cover panel to a vehicle frame such that the cover panel is held in place relative to the vehicle frame and such that the cover panel covers a portion of the vehicle frame. Specifically, in the embodiments shown, cover panel 30 is coupled to pillar 16.

In one embodiment, cover panel 30 is coupled to pillar 16 via an adhesive material such as adhesive layer 40 shown in FIGS. 2A and 2B. In such embodiments, the method includes placing an adhesive material between the first major surface of the cover panel and an exterior surface of the vehicle frame, and coupling the cover panel to a vehicle frame includes bonding the cover panel to the vehicle frame via the adhesive material.

In another embodiment, cover panel 30 is coupled to pillar 16 via a friction engagement, such as provided by panel frame 52, shown in FIGS. 3A and 3B. In some such embodiments, coupling the cover panel to a vehicle frame including holding the cover panel in a bent shape following bending to the vehicle frame via a panel frame that surrounds a perimeter of the glass article.

As a specific explanation of the cold-bending enabled by the thin glass material of cover panel 30 discussed herein, the stiffness of an article of glass is proportional to the cube of its thickness, as shown by Equation 1 below. A much greater force is required to bend a thick article of glass to a given radius of curvature than is needed to bend a thin article of glass to the same radius of curvature. The bending of glass to a specific radius results in the production of a bend stress (m) in the glass, as shown by Equation 2 below.

$$D = \frac{E * {t}^{3}}{12 ( 1 - {v}^{2} )} \qquad Equation 1$$

where D is Flexural Rigidity (stiffness), E is Young's Modulus of soda-lime glass, t is the glass thickness, and v is Poisson's ratio for glass.

$${σ}_{b} = \frac{t * E}{2 R} \qquad Equation 2$$

where E is Young's Modulus of soda-lime glass, t is the glass thickness, and R is radius of curvature.

Thus, the lower stiffness of the thin glass article used for cover panel 30 discussed herein results in a lower applied bend stress for a specific radius. For example, assuming a cover panel 30 that is bent to a fixed radius R, a thin, thermally strengthened soda-lime glass substrate of 0.7 mm thickness has 1/64^{th} the stiffness and ¼^{th} the induced bend stress of a 2.8 mm thick, conventionally strengthened soda-lime glass substrate with the same bend (i.e., the same fixed radius R). Thus, Applicant has found the thin thermally strengthened glass article discussed herein enables the use of cold bending to form a flat glass article into a non-flat shape of cover panel 30 without the need to heat the glass material to the glass softening temperature. For a cover panel application produced through cold bending, the thin glass article is selected to be thin enough to enable it to conform to the vehicle surface or to the upper surface of the plastic assembly element it is attached to while also meeting the reliability strength requirements for long term bending (fatigue) including the stresses of the in-service environment.

In specific embodiments, the thin glass cover panels, such as cover panel 30, discussed herein are particularly suited for use on vehicle locations where direct mechanical impacts (i.e., stones) from the road surface are not very likely. In such positions, in the event of an impact, the trajectories are at glancing angles, which minimize damage introduction and impact energy.

Referring to FIGS. 4-6, additional details and features of a glass article 60 used to form cover panel 30 are shown and described. Specifically, FIGS. 4 and 5 show a thin, thermally strengthened glass article 60 having a high surface compressive stress and/or a high central tension that may be used to form cover panel 30 according to an exemplary embodiment. FIG. 4 shows a front view of glass article 60, and FIG. 5 is a diagrammatic partial cross-section of cover panel 30 formed using glass article 60.

As shown in FIGS. 4 and 5, glass article 60 includes a first major surface, shown as interior surface 62 (indicated by the dotted line to the back side of glass article 60 in FIG. 4), a second major surface, shown as exterior surface 64, and an interior region or body 66 extending therebetween. Exterior surface 64 is on an opposite side of the body 66 from interior surface 62 such that a thickness T1 of the glass article 60 is defined as a distance between the interior surface 62 and the exterior surface 64, where the thickness T1 is also a dimension of depth. As discussed herein, T1 may be an average thickness or a maximum thickness. A width, W1, of glass article 60 is defined as a first dimension of one of the interior surface 62 and the exterior surface 64 orthogonal to the thickness T1. A length, L1, of glass article 60 is defined as a second dimension of one of the interior surface 62 and the exterior surface 64 orthogonal to both the thickness T1 and the width W1.

In various embodiments, T1 is less than 2 mm, specifically is 0.5 mm to 2 mm and more specifically is 0.7 mm to 2 mm. As noted herein these low thicknesses provide cover panel 30 with a low overall weight and flexibility suitable for cold-bending. Despite these low thicknesses, glass article 60 is also thermally strengthened to a level sufficient to provide strength and structural performance suitable for a vehicular cover panel application (e.g., break resistance, scratch resistance, dicing performance, etc.).

As shown in FIG. 5, glass article 60 further has a region 70 of permanent thermally induced compressive stress at or near exterior surface 64 and a region 72 of permanent thermally induced compressive stress at or near interior surface 62. Compressive stress regions 70 and 72 are balanced by an interior region 74 of permanent thermally induced central tensile stress (i.e., tension) in the central portion of glass article 60.

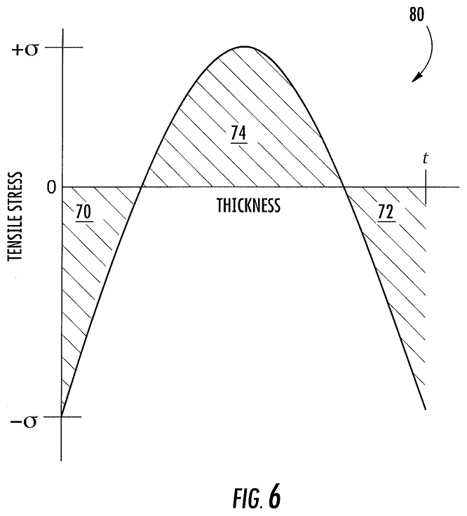

The thermally strengthened glass article discussed herein may have surprisingly high surface compressive stresses, e.g., in compressive stress regions 70, 72 shown in FIG. 5, surprisingly high central tensile stresses, e.g., in interior region 74 shown in FIG. 5, and/or unique stress profiles (see FIG. 6). This is particularly true considering the low thickness of glass article 60 as discussed herein.

In various embodiments, compressive stress within compressive stress regions 70 and/or 72 are at least 60 MPa, specifically at least 68 MPa and more specifically at least 100 MPa. In various embodiments, glass article 60 having a thickness, T1, of 2 mm or less has a compressive stress of at least 80 MPa, at least 100 MPa, at least 150 MPa, at least 175 MPa, at least 200 MPa, at least 250 MPa, at least 300 MPa, at least 350 MPa, at least 400 MPa, and/or no more than 1 GPa. In contemplated embodiments, glasses having a thickness of 1.5 mm or less have a compressive stress of at least 80 MPa, at least 100 MPa, at least 150 MPa, at least 175 MPa, at least 200 MPa, at least 250 MPa, at least 300 MPa, at least 350 MPa, and/or no more than 1 GPa. In contemplated embodiments, glasses having a thickness of 1 mm or less have a compressive stress of at least 80 MPa, at least 100 MPa, at least 150 MPa, at least 175 MPa, at least 200 MPa, at least 250 MPa, at least 300 MPa, and/or no more than 1 GPa.

In some embodiments, the thermally induced central tension in interior region 74 may be greater than 40 MPa, greater than 50 MPa, greater than 75 MPa, greater than 100 MPa. In other embodiments, the thermally induced central tension in interior region 74 may be less than 300 MPa, or less than 400 MPa. In some embodiments, the thermally induced central tension in interior region 74 may be from about 50 MPa to about 300 MPa, about 60 MPa to about 200 MPa, about 70 MPa to about 150 MPa, or about 80 MPa to about 140 MPa. In various embodiments, central tension in interior region 74 is greater than 70 MPa when the thickness, T1 is 1 mm to 2 mm, is greater than 80 MPa when T1 is between 0.7 mm and 1 mm and greater than 100 MPa when T1 is 0.7 mm. These levels of central tension at these thicknesses present in the glass article discussed herein are believed to be substantially higher than previously achieved.

In various embodiments, as noted above, cover panel 30 is designed to provide for a seamless and aesthetically appealing portion of a vehicle body. In such embodiments, cover panel 30 includes one or more non-transparent layers 76. In general, non-transparent layer 76 provides for the color and/or appearance desired for the body of car 10. As shown in FIG. 6, the non-transparent layer 76 is located on the interior surface 62 of glass article 60 and may define the interior surface 32 of cover panel 30. In specific embodiments, non-transparent layer 76 is formed from an opaque material such that visibility of pillar 16 is blocked when cover panel 30 is attached to pillar 16. In specific embodiments, non-transparent layer 76 is formed from at least one of an enamel frit material and an organic ink material.

Referring to FIG. 6, a conceptual stress profile 80, at room temperature of 25° C. and standard atmospheric pressure, of the glass article 60 of FIG. 4 is shown. FIG. 6 shows an interior region 74 of the glass article 60 under positive tensile stress, and compressive stress regions 70, 72 of the glass article 60 exterior to and adjoining the interior region 74 under negative tensile stress (e.g., positive compressive stress). Applicant believes that the negative tensile stress at least in part fortifies the strengthened glass article 60 by limiting initiation and/or propagation of cracks therethrough.

As shown in FIG. 6, tensile stress in the stress profile 80 sharply transitions between the positive tensile stress of the interior region 74 and the negative tensile stress of the compressive stress regions 70, 72 exterior to and adjoining the interior region 74. This sharp transition may be understood as a rate of change (i.e., slope) of the tensile stress which may be expressed as a magnitude of stress (e.g., 100 MPa, 200 MPa, 250 MPa, 300 MPa, 400 MPa, a difference in peak values of the positive and negative tensile stresses +σ, −σ) divided by a distance of thickness over which the change occurs, such as a distance of 1 mm, such as a distance of 500 μm, 250 μm, 100 μm (which is the distance used to quantify a rate of change, which may be a portion of article thickness, and not necessarily a dimension of the article geometry).

In some such embodiments, the rate of change of the tensile stress does not exceed 7000 MPa divided by 1 mm, such as no more than 5000 MPa divided by 1 mm. In contemplated embodiments, the difference in peak values of the positive and negative tensile stresses is at least 50 MPa, such as at least 100 MPa, at least 150 MPa, at least 200 MPa, at least 250 MPa, at least 300 MPa, at least 400 MPa, at least 500 MPa, and/or no more than 50 GPa. In contemplated embodiments, glass article 60 has a peak negative tensile stress of at least 50 MPa in magnitude, such as at least 100 MPa, at least 150 MPa, at least 200 MPa, at least 250 MPa, at least 300 MPa, at least 400 MPa, at least 500 MPa. The steep tensile curve transitions are believed to be indicative of the ability to achieve higher magnitudes of negative tensile stress at a surface of a glass article for a given thickness and/or to manufacture thinner glass articles to a higher degree of negative tensile stress, such as to achieve a fragmentation potential for dicing as disclosed herein.

According to an exemplary embodiment, the high rate of change of tensile stress is at least one of the above-described magnitudes or greater sustained over a thickness-wise stretch of the stress profile 80 that is at least 2% of the thickness, such as at least 5% of the thickness, at least 10% of the thickness, at least 15% of the thickness, or at least 25% of the thickness of glass article 60. In contemplated embodiments, the strengthening extends deep into the strengthened glass article 60 such that the thickness-wise stretch with the high rate of change of tensile stress is centered at a depth of between 20% and 80% into the thickness from the first surface, which may further distinguish chemical strengthening, for example.

In various embodiments, glass article 60 is not chemically strengthened via a process such as ion exchange/implantation. In such embodiments, the ion content and chemical constituency of at least portions of compressive stress regions 70 and 72 of glass article 60, which are under the negative tensile stress, is the same as the ion content and chemical constituency of at least a portion of the interior region 74, which is under the positive tensile stress. In specific embodiments, the ion content and chemical constituency of the entire compressive stress regions 70 and 72 of glass article 60 is the same as the ion content and chemical constituency of the entire interior region 74. Additional details and methods for forming a thin, thermally strengthened glass article, such as glass article 60, can be found in U.S. Pat. No. 9,296,638, which is incorporated by reference herein in its entirety.

Aspect (1) of this disclosure pertains to a vehicle frame assembly comprising: a vehicle frame support structure having an interior surface and an exterior surface; and a cover panel coupled to the vehicle frame support structure and covering the exterior surface of the vehicle frame support structure, the cover panel comprising: a glass article comprising: a first major surface; a second major surface opposite the first major surface and separated from the first major surface by a thickness, wherein the thickness is less than or equal to 2 mm; and an interior region located between the first and second major surfaces; and wherein the glass article is thermally strengthened such that at least one of the first major surface and the second major surface is under compressive stress greater than 60 MPa; wherein the first major surface faces the exterior surface of the vehicle frame support structure.

Aspect (2) pertains to the vehicle frame assembly of Aspect (1), wherein the glass article is not chemically strengthened such that an ion content and chemical constituency of at least a portion of both the first major surface and the second major surface is the same as an ion content and chemical constituency of at least a portion of the interior region.

Aspect (3) pertains to the vehicle frame assembly of Aspect (1) or Aspect (2), further comprising a non-transparent colored layer located on the first major surface of the glass article.

Aspect (4) pertains to the vehicle frame assembly of Aspect (3), wherein the non-transparent colored layer is opaque.

Aspect (5) pertains to the vehicle frame assembly of any one of Aspects (1) through (4), further comprising an adhesive material located between the first major surface of the glass article and the exterior surface of the vehicle frame support structure, the adhesive material coupling the glass article to the vehicle frame support structure.

Aspect (6) pertains to the vehicle frame assembly of any one of Aspects (1) through (5), further comprising a panel frame, wherein: the glass article further comprises an outer edge surface extending between and surrounding the first and second major surfaces such that the outer edge surface defines a perimeter of the glass article; the panel frame comprises a first end that engages the glass article and a second end that engages the vehicle frame support structure; and the panel frame holds the glass article in place relative to the vehicle frame support structure via friction.

Aspect (7) pertains to the vehicle frame assembly of any one of Aspects (1) through (6), wherein: at least a portion of the exterior surface of the vehicle frame support structure is a curved surface comprising a first radius of curvature; the glass article is curved such that the first major surface of the glass article comprises a second radius of curvature; and the second radius of curvature substantially matches the first radius of curvature.

Aspect (8) pertains to the vehicle frame assembly of any one of Aspects (1) through (7), wherein the second major surface of the glass article defines an outermost surface of the vehicle frame assembly and includes an outer peripheral edge that is located adjacent to a vehicle window.

Aspect (9) pertains to the vehicle frame assembly of any one of Aspects (1) through (8), wherein the thickness of the glass article is 0.5 mm to 2 mm, and the compressive stress of at least one of the first major surface and the second major surface is greater than 100 MPa.

Aspect (10) pertains to the vehicle frame assembly of any one of Aspects (1) through (9), wherein the thickness of the glass article comprises an average thickness of the glass article.

Aspect (11) pertains to the vehicle frame assembly of any one of Aspects (1) through (10), wherein the thickness of the glass article comprises a maximum thickness of the glass article.

Aspect (12) pertains to a method of forming a vehicle frame assembly comprising: bending a glass article to a curved shape while a temperature of the glass article is less than a glass transition temperature of the glass article, wherein the glass article comprises: a first major surface; a second major surface opposite the first major surface and separated from the first major surface by a thickness, wherein the thickness is less than or equal to 2 mm; and an interior region located between the first and second major surfaces; and wherein the glass article is thermally strengthened such that at least one of the first major surface and the second major surface is under compressive stress greater than 60 MPa; and coupling the glass article to a vehicle frame such that the glass article is held in place relative to the vehicle frame covering a portion of the vehicle frame.

Aspect (13) pertains to the method of Aspect (12), wherein an exterior facing surface of the vehicle frame is a curved surface having a first radius of curvature, and bending further comprises bending the glass article such that the first major surface of the glass article comprises a second radius of curvature that substantially matches the first radius of curvature.

Aspect (14) pertains to the method of Aspect (12), further comprising placing an adhesive material between the first major surface of the glass article and an exterior surface of the vehicle frame, wherein coupling the glass article to a vehicle frame comprises bonding the glass article to the vehicle frame via the adhesive material.

Aspect (15) pertains to the method of any one of Aspects (12) through (14), wherein coupling the glass article to a vehicle frame comprises holding the glass article in a bent shape following bending to the vehicle frame via a panel frame that surrounds a perimeter of the glass article and that holds the glass article to the vehicle frame via a friction fit.

Aspect (16) pertains to the method of any one of Aspects (12) through (15), wherein the second major surface of the glass article defines an outermost surface of the vehicle frame assembly at the location of the portion of the vehicle frame and includes an outer peripheral edge that is located adjacent to a vehicle window.

Aspect (17) pertains to the method of Aspect (16), wherein the portion of the vehicle frame is a support pillar extending along a vertical edge of the vehicle window, wherein the glass article further comprises a peripheral edge that extends along the vertical edge of the vehicle window.

Aspect (18) pertains to the method of any one of Aspects (12) through (17), wherein the glass article is not chemically strengthened such that an ion content and chemical constituency of at least a portion of both the first major surface and the second major surface is the same as an ion content and chemical constituency of at least a portion of the interior region.

Aspect (19) pertains to the method of any one of Aspects (12) through (18), further comprising a non-transparent colored layer located on the first major surface of the glass article.

Aspect (20) pertains to the method of Aspect (19), wherein the non-transparent colored layer is opaque.

Aspect (21) pertains to the method of any one of Aspects (12) through (20), wherein the thickness of the glass article is 0.5 mm to 2 mm, and the compressive stress of at least one of the first major surface and the second major surface is greater than 100 MPa.

Aspect (22) pertains to a glass cover panel for covering a portion of a vehicle frame comprising: a glass article comprising: a first major surface; a second major surface opposite the first major surface and separated from the first major surface by a thickness, wherein the thickness is less than or equal to 2 mm; and an interior region located between the first and second major surfaces; and wherein the glass article is thermally strengthened such that at least one of the first major surface and the second major surface is under compressive stress greater than 60 MPa; wherein the glass article is not chemically strengthened such that an ion content and chemical constituency of at least a portion of both the first major surface and the second major surface is the same as an ion content and chemical constituency of at least a portion of the interior region; wherein at least a portion of the first major surface is a curved surface comprising a first radius of curvature, wherein the first radius of curvature is between 500 mm and 3000 mm; and a non-transparent colored layer located on the first major surface of the glass article.

Aspect (23) pertains to the glass cover panel of Aspect (22), wherein the non-transparent colored layer is opaque.

Aspect (24) pertains to the glass cover panel of Aspect (23), the non-transparent colored layer is at least one of an enamel frit material and an organic ink material.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

1. A vehicle frame assembly comprising:
a vehicle frame support structure having an interior surface and an exterior surface; and
a cover panel coupled to the vehicle frame support structure and covering the exterior surface of the vehicle frame support structure, the cover panel comprising:
a glass article comprising:
a first major surface;
a second major surface opposite the first major surface and separated from the first major surface by a thickness, wherein the thickness is less than or equal to 2 mm; and
an interior region located between the first and second major surfaces; and
wherein the glass article is thermally strengthened such that at least one of the first major surface or the second major surface is under compressive stress greater than 60 MPa;
wherein the first major surface faces the exterior surface of the vehicle frame support structure.

2. The vehicle frame assembly of claim 1, wherein the glass article is not chemically strengthened such that an ion content and chemical constituency of at least a portion of both the first major surface and the second major surface is the same as an ion content and chemical constituency of at least a portion of the interior region.

3. The vehicle frame assembly of claim 1, further comprising a non-transparent colored layer located on the first major surface of the glass article.

4. The vehicle frame assembly of claim 3, wherein the non-transparent colored layer is opaque.

5. The vehicle frame assembly of claim 1, further comprising an adhesive material located between the first major surface of the glass article and the exterior surface of the vehicle frame support structure, the adhesive material coupling the glass article to the vehicle frame support structure.

6. The vehicle frame assembly of claim 1, further comprising a panel frame, wherein:
the glass article further comprises an outer edge surface extending between and surrounding the first and second major surfaces such that the outer edge surface defines a perimeter of the glass article;
the panel frame comprises a first end that engages the glass article and a second end that engages the vehicle frame support structure; and
the panel frame holds the glass article in place relative to the vehicle frame support structure via friction.

7. The vehicle frame assembly of claim 1, wherein:
at least a portion of the exterior surface of the vehicle frame support structure is a curved surface comprising a first radius of curvature;
the glass article is curved such that the first major surface of the glass article comprises a second radius of curvature; and
the second radius of curvature substantially matches the first radius of curvature.

8. The vehicle frame assembly of claim 1, wherein the second major surface of the glass article defines an outermost surface of the vehicle frame assembly and includes an outer peripheral edge that is located adjacent to a vehicle window.

9. The vehicle frame assembly of claim 1, wherein the thickness of the glass article is 0.5 mm to 2 mm, and the compressive stress of at least one of the first major surface or the second major surface is greater than 100 MPa.

10. The vehicle frame assembly of claim 1, wherein the thickness of the glass article comprises an average thickness of the glass article.

11. The vehicle frame assembly of claim 1, wherein the thickness of the glass article comprises a maximum thickness of the glass article.

12. A method of forming a vehicle frame assembly comprising:
bending a glass article to a curved shape while a temperature of the glass article is less than a glass transition temperature of the glass article, wherein the glass article comprises:
a first major surface;
a second major surface opposite the first major surface and separated from the first major surface by a thickness, wherein the thickness is less than or equal to 2 mm; and
an interior region located between the first and second major surfaces; and
wherein the glass article is thermally strengthened such that at least one of the first major surface or the second major surface is under compressive stress greater than 60 MPa; and
coupling the glass article to a vehicle frame such that the glass article is held in place relative to the vehicle frame covering a portion of the vehicle frame.

13. The method of claim 12, wherein an exterior facing surface of the vehicle frame is a curved surface having a first radius of curvature, and the bending further comprises bending the glass article such that the first major surface of the glass article comprises a second radius of curvature that substantially matches the first radius of curvature.

14. The method of claim 12, further comprising placing an adhesive material between the first major surface of the glass article and an exterior surface of the vehicle frame, wherein the coupling the glass article to the vehicle frame comprises bonding the glass article to the vehicle frame via the adhesive material.

15. The method of claim 12, wherein the coupling the glass article to the vehicle frame comprises holding the glass article in a bent shape following the bending via a panel frame that surrounds a perimeter of the glass article and holds the glass article to the vehicle frame via a friction fit.

16. The method of claim 12, wherein the second major surface of the glass article defines an outermost surface of the vehicle frame assembly at the location of the portion of the vehicle frame and includes an outer peripheral edge located adjacent to a window of the vehicle.

17. The method of claim 16, wherein the portion of the vehicle frame is a support pillar extending along a vertical edge of the vehicle window, wherein the glass article further comprises a peripheral edge that extends along a vertical edge of the vehicle window.

18. The method of claim 12, wherein the glass article is not chemically strengthened such that an ion content and chemical constituency of at least a portion of both the first major surface and the second major surface is the same as an ion content and chemical constituency of at least a portion of the interior region.

19. The method of claim 12, further comprising a non-transparent colored layer located on the first major surface of the glass article.

20. The method of claim 19, wherein the non-transparent colored layer is opaque.

21. The method of claim 12, wherein the thickness of the glass article is 0.5 mm to 2 mm, and the compressive stress of at least one of the first major surface or the second major surface is greater than 100 MPa.

22. A glass cover panel for covering a portion of a vehicle frame comprising:
a glass article comprising:
a first major surface;
a second major surface opposite the first major surface and separated from the first major surface by a thickness, wherein the thickness is less than or equal to 2 mm; and
an interior region located between the first and second major surfaces; and
wherein the glass article is thermally strengthened such that at least one of the first major surface or the second major surface is under compressive stress greater than 60 MPa;
wherein the glass article is not chemically strengthened such that an ion content and chemical constituency of at least a portion of both the first major surface and the second major surface is the same as an ion content and chemical constituency of at least a portion of the interior region;
wherein at least a portion of the first major surface is a curved surface comprising a first radius of curvature, wherein the first radius of curvature is between 500 mm and 3000 mm; and
a non-transparent colored layer located on the first major surface of the glass article.

23. The glass cover panel of claim 22, wherein the non-transparent colored layer is opaque.

24. The glass cover panel of claim 23, wherein the non-transparent colored layer is at least one of an enamel frit material or an organic ink material.
